(19) United States
(12) Patent Application Publication
(10) Pub. No.: US 2016/0164320 A1
(43) Pub. Date: Jun. 9, 2016

(54) CHARGING SYSTEM WITH AN ENHANCED CHARGING EFFICIENCY AND CHARGING DEVICE AND POWER STORAGE EQUIPMENT

(71) Applicant: MASTERHOLD INT'L CO., LTD., New Taipei City (TW)

(72) Inventor: Chung-Ho LO, New Taipei City (TW)

(73) Assignee: MASTERHOLD INT'L CO., LTD., New Taipei City (TW)

(21) Appl. No.: 14/636,250

(22) Filed: Mar. 3, 2015

(30) Foreign Application Priority Data
Dec. 4, 2014 (TW) 103142080

(51) Int. Cl. H02J 7/00

(52) U.S. Cl. CPC H02J 7/0042; H02J 7/0013

(57) ABSTRACT

A charging system with an enhanced charging efficiency has two connectors each having multiple connection points, which are connected between multiple chargers and multiple rechargeable batteries. The chargers are connected to one of the connectors through multiple first connection wire sets. The other connector is connected to the rechargeable batteries through multiple second connection wire sets. Output terminals of the chargers and the positive and negative terminals of the rechargeable batteries are respectively connected to the connectors. Thus, the chargers receive power through a power input port and output power converted thereby to the rechargeable batteries through single-port connection of the connectors in a one-to-one fashion to achieve the purpose of simultaneously and efficiently charging multiple rechargeable batteries and providing operational convenience because of the easy and convenient connection of the connectors.

### BACKGROUND OF THE INVENTION

1. Field of the Invention

The present invention relates to a charging system and, more particularly, to a charging system with an enhanced charging efficiency and a charging device and power storage equipment of the charging system.

2. Description of the Related Art

Secondary batteries have been most widely applied to conventional charging systems. The secondary batteries can be repeatedly charged for use and are thus convenient in operation and are satisfactory as far as economic benefits are concerned. With reference to FIG. 3, a conventional series-connected rechargeable battery charging system is composed of an AC (Alternating Current) to DC (Direct Current) conversion circuit 40, an AC mains power source 41, and a series-connected battery set.

The AC to DC conversion circuit 40 includes a set of AC input terminals and a set of DC output terminals. The set of AC input terminals of the AC to DC conversion circuit 40 is connected to the AC mains power source 41 to receive an AC mains power. The AC to DC conversion circuit 40 converts the AC mains power into a DC power. The set of DC output terminals of the AC to DC conversion circuit 40 is electrically connected to two ends of the series-connected battery set. The battery set has a first battery 42, a second battery 43, a third battery 44, and a fourth battery 45. The negative electrode of the first battery 42 is connected to the positive electrode of the second battery 43, the negative electrode of the second battery 43 is connected to the positive electrode of the third battery 44, and the negative electrode of the third battery 44 is connected to the positive electrode of the fourth battery 45 to constitute the series-connected battery set. The positive electrode of the first battery 42 and the negative terminal of the fourth battery 45 are electrically connected to the set of DC output terminals of the AC to DC conversion circuit 40, such that the converted DC power can simultaneously charge all the batteries 42-45. However, such conventional series-connected rechargeable battery charging system oftentimes encounters unbalanced charging phenomenon during the charging process, especially to the first battery 42 that is easily over-charged. Other issues, such as no scheduling charge and sequential charge, uneven charging, over-charge, over-discharge can hardly be overcome.

As disclosed in Taiwan Utility Model Patent No. M484193, entitled “Charging set for charging storage battery unit body” (hereinafter “prior art”), the charging set is composed of a rechargeable battery and a charger. The rechargeable battery includes a battery body and multiple battery units mounted inside the battery body. The battery body has a hole formed through a sidewall of the battery body for the internal battery units to be connected to the external charger. The charger has a power output unit electrically connected to each battery unit through the hole on the sidewall of the battery body and supplying power to each battery unit.

As can be seen from the foregoing conventional technique, in view of the reason that the series-connected rechargeable battery charging system is arranged in a series-connected manner to perform charging, unbalanced charge, over-charge, and over-discharge to the battery set can easily occur and the features of scheduling charge, sequential charge, and uniform charge are also not available. On the other hand, the prior art distributes power to all the battery units through the power output unit of the charger to prevent the over-charge issue in the first battery 42 of the series-connected rechargeable battery charging system from happening. However, the charger still has the issues of low, high, or unstable voltage upon charging, which easily damage the battery and affect charging performance.

### SUMMARY OF THE INVENTION

An objective of the present invention is to provide a charging system with an enhanced charging efficiency for multiple chargers in a charging device to simultaneously charge multiple rechargeable batteries of power storage equipment in a one-to-one fashion and maintain uniform charging of the rechargeable batteries for the purpose of higher charging efficiency.

To achieve the foregoing objective, the charging system includes a charging device and power storage equipment.

The charging device has a power input port, multiple chargers, and a first connector.

The power input port is connected to a power terminal.

Each charger has a power output terminal and a power input terminal connected to the power input port.

The first connector has multiple first connection points respectively connected to the power output terminals of the multiple chargers through multiple first connection wire sets.

The power storage equipment has a battery set and a second connector.

The battery set has multiple rechargeable batteries, and each battery has a positive terminal and a negative terminal.

The second connector has multiple second connection points connected to corresponding positive terminals and negative terminals of the multiple rechargeable batteries through multiple second connection wire sets.

The first connector is electrically connected to the power storage equipment through single-port connection for the power storage equipment to simultaneously receive converted power from the multiple chargers, and the multiple first connection points of the first connector are respectively connected to the multiple second connection points of the second connector through point-to-point connection for the multiple chargers to respectively charge multiple rechargeable batteries of the power storage equipment in a one-to-one fashion.

Given the foregoing charging system, the charging device has multiple chargers and the power storage equipment also has corresponding number of rechargeable batteries, and the first connector of the charging device and the second connector of the power storage equipment are electrically connected. When users intend to charge the power storage equipment with the charging device and the power from the power terminal is received by the charging device through the power input port, the multiple chargers convert the received power to supply power. Furthermore, the multiple chargers are respectively connected to the multiple first connection points of the first connector through the multiple first connection wire sets, and the multiple second connection points of the second connector are connected to the multiple rechargeable batteries through the multiple second connection wire sets. The connection points of the first connector and the second connector are mutually electrically connected through point-to-point connection, such that the power supplied from each charger can be solely sent to a corresponding rechargeable battery to achieve the purpose of simultaneously charging multiple rechargeable batteries at a high charging efficiency. Moreover, as the first connector and the second connector can be connected through single-port connection, operational convenience can be also ensured.

### BRIEF DESCRIPTION OF THE DRAWINGS

FIG. 1 is a circuit block diagram of a first embodiment of a charging system with enhanced charging efficiency in accordance with the present invention;

FIG. 2 is a circuit block diagram of a second embodiment of a charging system with enhanced charging efficiency in accordance with the present invention; and

FIG. 3 is a circuit block diagram of a conventional series-connected rechargeable battery charging system.

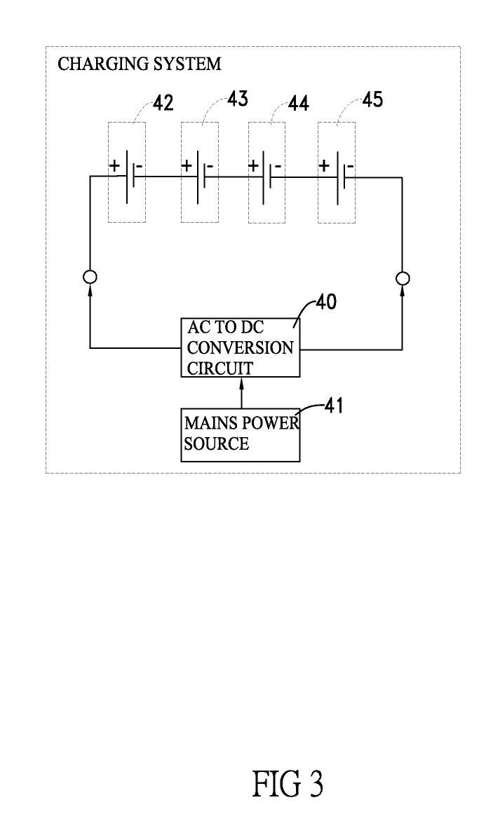

### DETAILED DESCRIPTION OF THE INVENTION

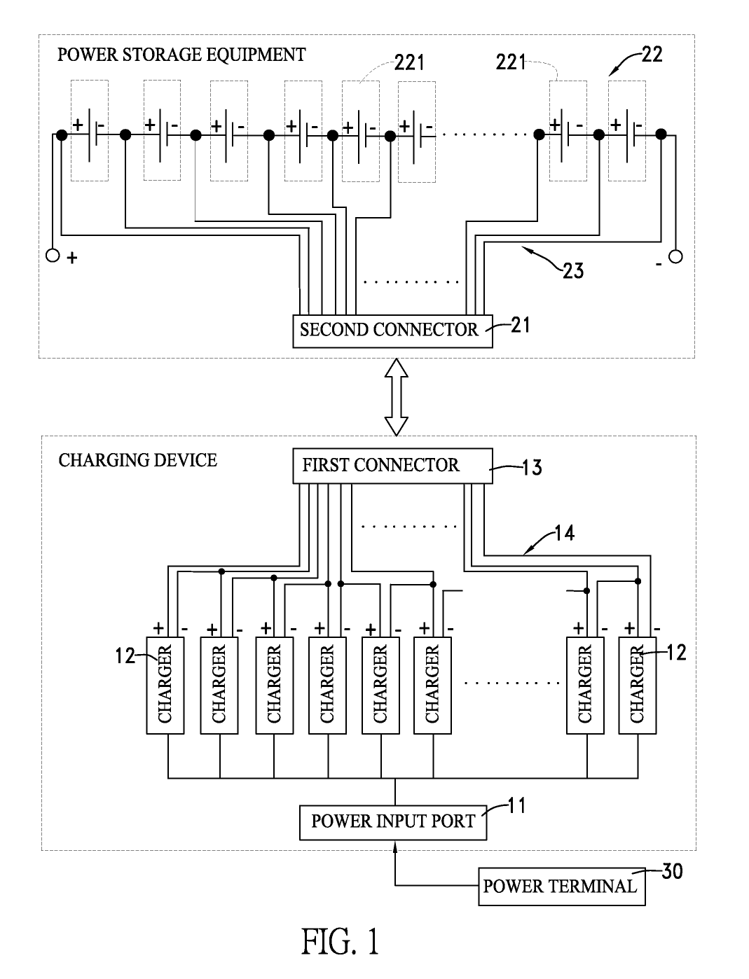

With reference to FIG. 1, a first embodiment of a charging system with an enhanced charging efficiency in accordance with the present invention includes a charging device, power storage equipment, and a power terminal 30.

The charging device has a power input port 11, multiple chargers 12, a first connector 13, and multiple first connection wire sets 14. The power input port 11 is connected to the power terminal 30. Each charger 12 has a power input terminal and a power output terminal. The power input terminals of the multiple chargers 12 are electrically connected to the power input port 11 for each charger 12 to receive a power from the power terminal 30 through one of the power input terminals and to convert the received power into another power for output.

The first connector 13 has multiple first connection points respectively connected to the power output terminals of the multiple chargers 12 through the multiple first connection wire sets 14. Each first connection wire set 14 has a first end and a second end. The first end of the first connection wire set 14 is connected to a corresponding first connection point of the first connector 13, and the second end of the first connection wire set 14 is connected to the power output terminal of a corresponding charger 12. In the present embodiment, the first connector 13 further has multiple electrical connection members. Each electrical connection member has a corresponding first connection point formed thereon and electrically connected to the power output terminal of a corresponding charger 12 through one of the multiple first connection wire sets 14. Each electrical connection member of the first connector 13 may be a metal pin or a metal terminal, which is round or square in shape, thus making the first connector 13 a multi-pin connector.

In the present embodiment, the power output terminal of each charger 12 has a first power terminal (positive electrode) and a second power terminal (negative electrode), the first power terminal of one of the two outermost chargers 12 is connected to one of the two outermost first connection points of the first connector 13, the second power terminal of the other outermost charger 12 is connected to the other outermost first connection point of the first connector 13, and the second power terminal of each of the remaining chargers 12 and the first power terminal of the next charger 12 are combined to constitute a first common terminal connected to one of the remaining first connection points of the first connector 13 through a corresponding first connection wire set 14. Therefore, the multiple power output terminals of the multiple chargers 12 can be concentrated through the use of the first connector 13, and the power generated by the multiple chargers 12 can be supplied to the power storage equipment.

With further reference to FIG. 1, the power storage equipment receives the converted power outputted from the charging device, and has a second connector 21, a series-connected battery set 22, and multiple second connection wire sets 23. The second connector 21 is compatible with the first connector 13 and has multiple second connection points connected to the battery set 22 through the multiple second connection wire sets 23. Each second connection wire set 23 has a first end and a second end. The first end of the second connection wire set 23 is connected to a corresponding second connection point of the second connector 21, and the second end of the second connection wire set 23 is connected to the battery set 22. In the present embodiment, the second connector 21 further has multiple electrical connection members compatible with the electrical connection members of the first connector 13. Each electrical connection member of the second connector 21 has a corresponding second connection point formed thereon and electrically connected to the first connection point of a corresponding electrical connection member of the first connector through one of the multiple second connection wire sets 23. Each electrical connection member of the second connector 21 may be a metal pin or a metal terminal, which is round or square in shape, thus making the second connector 21 a multi-pin connector.

The battery set 22 has a positive terminal and a negative terminal and has multiple rechargeable batteries 221 series-connected to each other. The positive terminal of the battery set 22 and the negative terminal of the battery set 22 are respectively connected to two corresponding second connection points of the second connector 21 through two corresponding second connection wire sets 23 to receive the converted power from each charger 12. It is noted that the positive terminal of the battery set 22 indicates a positive terminal of the heading rechargeable battery 221 of the battery set 22, and the negative terminal of the battery set 22 indicates a negative terminal of the trailing rechargeable battery 221 of the battery set 22. In the present embodiment, a second common terminal is connected between each two adjacent rechargeable batteries 221 of the battery set 22 and is connected to a corresponding one of the remaining second connection points of the second connector 21 through one of the remaining second connection wire sets 23. As the second connector 21 is compatible with the first connector 13, the second connection points of the second connector 21 are respectively connected to the first connection points of the first connector 13, such that the second common terminals of the battery set 22 are respectively connected to the first common terminals of the multiple chargers 12.

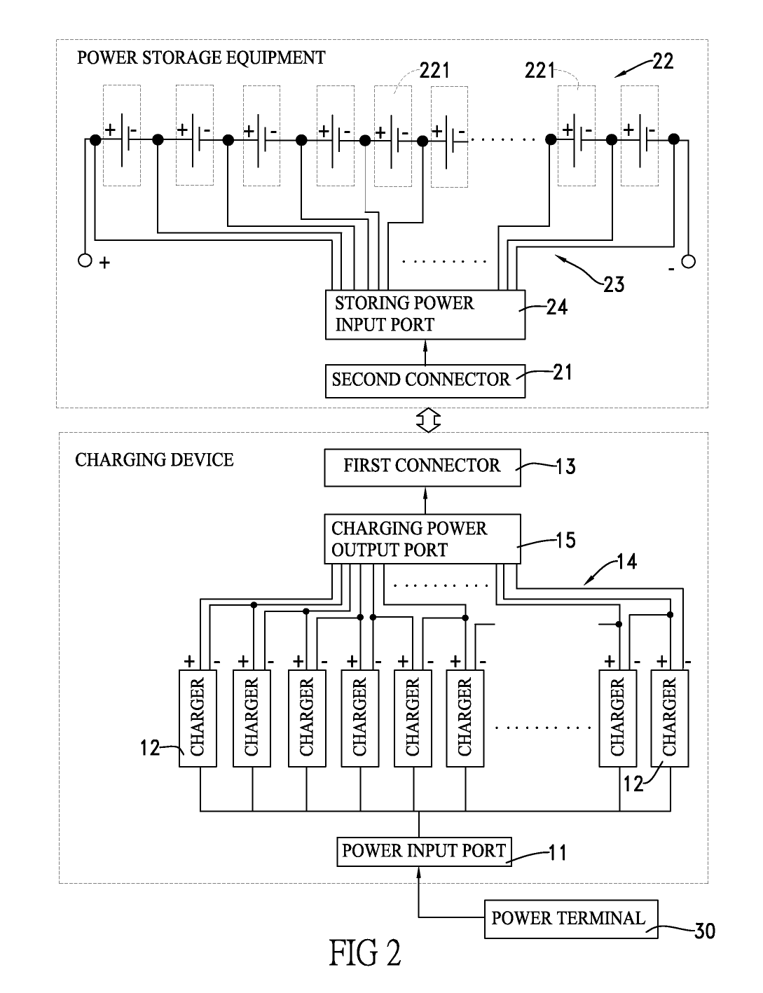

With reference to FIG. 2, a second embodiment of a charging system with an enhanced charging efficiency in accordance with the present invention differs from the foregoing embodiment in that the charging device further has a charging power output port 15 and the power storage equipment further has a storing power input port 24.

The charging power output port 15 of the charging device has multiple power input terminals corresponding to the multiple chargers 12 and multiple power output terminals corresponding to the first connector 13. The multiple power input terminals of the charging power output port 15 are connected to corresponding power output terminals of the multiple chargers 12 through corresponding first connection wire sets 14. The multiple power output terminals of the charging power output port 15 are respectively connected to the multiple first connection points of the first connector 13 for the converted power from the multiple chargers 12 to be outputted to the power storage equipment through the first connector 13.

The storing power input port 24 of the power storage equipment has multiple power input terminals corresponding to the second connector 21 and multiple power output terminals corresponding to the battery set 22. The multiple power input terminals of the storing power input port 24 are respectively connected to the multiple second connection points of the second connector 21. The multiple power output terminals of the storing power input port 24 are respectively connected to the corresponding positive terminals, negative terminals, and second common terminals of the multiple rechargeable batteries 221. The multiple first connection points of the first connector 13 and the second connection points of the second connector 21 are electrically connected to each other through the way of point-to-point connection or single-port connection, such that the respectively converted power from the multiple chargers can charge the multiple rechargeable batteries 221 in a one-to-one fashion and the multiple rechargeable batteries 221 of the battery set 22 in the power storage equipment can simultaneously receive the respective converted power.

To explain how the foregoing embodiments can be applied for operation, a charging system with an enhanced charging efficiency including the charging device, the power storage equipment, and the power terminal 30 as mentioned in the foregoing descriptions is provided. The charging device has the multiple chargers 12, the first connector 13, and the multiple first connection wire sets 14. The power storage equipment has the second connector 21, the series-connected battery set 22, and the multiple second connection wire sets 23. Each charger 12 has an AC to DC converter. When the power terminal 30 is connected to a mains power and provides an AC power, the AC power is inputted to each charger 12 through a corresponding power input terminal of the charger 12. The AC to DC converter converts the AC power into a DC power that is outputted to the first connector 13 through the power output terminal of the charger 12 through a corresponding first connection wire set 14. The charging device is electrically connected to the second connector 21 of the power storage equipment through the first connector 13. The DC power is transmitted to the power storage equipment through the first connector 13 and the second connector 21 connected to the first connector 13.

During actual implementations, the number of the multiple chargers 12 and the number of the multiple rechargeable batteries 221 may each be a multiple of four, and the multiple chargers 12 and the multiple rechargeable batteries 221 correspond to each other in number. For example, if the battery set 22 of the power storage equipment has sixteen series-connected rechargeable batteries 221 and the charging voltage of the multiple rechargeable batteries 221 is presumed to be 3.6V, the charging device also provides sixteen chargers 12 whose specifications are 3.6V and 10 A. The specifications of the chargers may vary with the specifications of the rechargeable batteries 221. The first power terminal (positive electrode) of one of the two outermost chargers 12, the second power terminal (negative electrode) of the other outermost charger 12, and the first common terminals formed by commonly connecting each of the remaining second power terminals of a corresponding charger 12 with the first power terminal of the charger 12 next to the corresponding charger 12 are respectively connected to the first connection points of the first connector 13. Thus, seventeen first connection wire sets are required, which is connected to the first connector 13 with seventeen pins. To be compatible with the first connector, the second connector 21 of the power storage equipment also has seventeen pins. The second connector 21 is further connected to the battery set 22 through seventeen second connection wire sets 23. Given the foregoing circuit structure, the converted DC power can be respectively distributed to the multiple rechargeable batteries 221 to charge the multiple rechargeable batteries 221 in a one-to-one fashion to avoid the issues of over-charge and low, high, or unstable DC charging voltage. When the multiple rechargeable batteries 221 are charged according to the foregoing description, not only can the charging efficiency be enhanced, but also the way of connecting the first connector 13, the multiple first connection wire sets 14, the second connector 21, and the multiple second connection wire sets 23 is rather easy and convenient, thereby further increasing the operational convenience.

What is claimed is:

1. A charging device of a charging system with an enhanced charging efficiency, comprising:
a power input port connected to a power terminal;
multiple chargers, each charger having:
a power output terminal; and
a power input terminal connected to the power input port;
a first connector having multiple first connection points respectively connected to the power output terminals of the multiple chargers through multiple first connection wire sets;
wherein the first connector is adapted to electrically connect to power storage equipment having multiple rechargeable batteries through single-port connection for the power storage equipment to simultaneously receive converted power from the multiple chargers, and the multiple first connection points of the first connector are respectively connected to multiple second connection points of a second connector through point-to-point connection for the multiple chargers to respectively charge the multiple rechargeable batteries of the power storage equipment in a one-to-one fashion.

2. The charging device as claimed in claim 1, wherein the first connector has multiple electrical connection members, and each electrical connection member has one of the multiple first connection points formed thereon and is a metal pin or a metal terminal.

3. The charging device as claimed in claim 2, wherein the power output terminal of each charger includes a first power terminal and a second power terminal, the first power terminal of one of the two outermost chargers is connected to one of the two outermost first connection points of the first connector, the second power terminal of the other outermost charger is connected to the other outermost first connection point of the first connector, and the second power terminal of each of the remaining chargers and the first power terminal of the next charger are combined to constitute a first common terminal connected to one of the remaining first connection points of the first connector through a corresponding first connection wire set.

4. The charging device as claimed in claim 1, wherein the charging device further has a charging power output port, wherein the charging power output port has:
multiple power input terminals corresponding to the multiple chargers and connected to the power output terminals of the multiple chargers through the first connection wire sets; and
multiple power output terminals corresponding to the first connector and respectively connected to the multiple first connection points of the first connector.

5. The charging device as claimed in claim 2, wherein the charging device further has a charging power output port, wherein the charging power output port has:
multiple power input terminals corresponding to the multiple chargers and connected to the power output terminals of the multiple chargers through the first connection wire sets; and
multiple power output terminals corresponding to the first connector and respectively connected to the multiple first connection points of the first connector.

6. The charging device as claimed in claim 3, wherein the charging device further has a charging power output port, wherein the charging power output port has:
multiple power input terminals corresponding to the multiple chargers and connected to the power output terminals of the multiple chargers through the first connection wire sets; and
multiple power output terminals corresponding to the first connector and respectively connected to the multiple first connection points of the first connector.

7. Power storage equipment of a charging system with an enhanced charging efficiency, comprising:
a battery set having multiple rechargeable batteries, wherein each battery has a positive terminal and a negative terminal; and
a second connector having multiple second connection points correspondingly connected to the positive terminals and the negative terminals of the multiple rechargeable batteries through multiple second connection wire sets;
wherein the second connector is adapted to electrically connect to a charging device through single-port connection for the battery set of the power storage equipment to simultaneously receive converted power from multiple chargers of the charging device, and the multiple second connection points of the second connector are connected to the multiple rechargeable batteries through point-to-point connection for the multiple rechargeable batteries to be respectively charged by the multiple chargers of the charging device in a one-to-one fashion.

8. The power storage equipment as claimed in claim 7, wherein the second connector has multiple electrical connection members, and each electrical connection member has one of the multiple second connection points formed thereon and is a metal pin or a metal terminal.

9. The power storage equipment as claimed in claim 8, wherein the multiple rechargeable batteries are connected in series, the positive terminal of the heading rechargeable battery and the negative terminal of the trailing rechargeable battery of the battery set are respectively connected to two corresponding second connection points of the second connector through two corresponding second connection wire sets, and a second common terminal is connected between each two adjacent rechargeable batteries of the battery set and is connected to a corresponding one of the remaining second connection points of the second connector through one of the remaining second connection wire sets.

10. The power storage equipment as claimed in claim 7, wherein the power storage equipment further has a storing power input port, and the storing power input port of the power storage equipment has:
multiple power input terminals corresponding to the second connector and respectively connected to the multiple second connection points of the second connector; and
multiple power output terminals corresponding to the battery set and respectively connected to the corresponding positive terminals, negative terminals, and second common terminals of the multiple rechargeable batteries.

11. The power storage equipment as claimed in claim 8, wherein the power storage equipment further has a storing power input port, and the storing power input port of the power storage equipment has:
multiple power input terminals corresponding to the second connector and respectively connected to the multiple second connection points of the second connector; and
multiple power output terminals corresponding to the battery set and respectively connected to the corresponding positive terminals, negative terminals, and second common terminals of the multiple rechargeable batteries.

12. The power storage equipment as claimed in claim 9, wherein the power storage equipment further has a storing power input port, and the storing power input port of the power storage equipment has:
multiple power input terminals corresponding to the second connector and respectively connected to the multiple second connection points of the second connector; and
multiple power output terminals corresponding to the battery set and respectively connected to the corresponding positive terminals, negative terminals, and second common terminals of the multiple rechargeable batteries.

13. A charging system with an enhanced charging efficiency, comprising:
a charging device having:
a power input port connected to a power terminal;
multiple chargers, each charger having:
a power output terminal; and
a power input terminal connected to the power input port;
a first connector having multiple first connection points respectively connected to the power output terminals of the multiple chargers through multiple first connection wire sets; and
power storage equipment having:
a battery set having multiple rechargeable batteries, wherein each battery has a positive terminal and a negative terminal; and
a second connector having multiple second connection points correspondingly connected to the positive terminals and the negative terminals of the multiple rechargeable batteries through multiple second connection wire sets;
wherein
the first connector is electrically connected to the power storage equipment through single-port connection for the power storage equipment to simultaneously receive converted power from the multiple chargers, and the multiple first connection points of the first connector are connected to the multiple second connection points of the second connector through point-to-point connection for the multiple chargers to respectively charge the multiple rechargeable batteries of the power storage equipment in a one-to-one fashion; and
the second connector is adapted to electrically connect to the charging device through single-port connection for the battery set of the power storage equipment to simultaneously receive converted power from the multiple chargers of the charging device, and the multiple second connection points of the second connector are connected to the multiple rechargeable batteries through point-to-point connection for the multiple rechargeable batteries to be respectively charged by the multiple chargers of the charging device in a one-to-one fashion.

14. The charging system as claimed in claim 13, wherein the first connector and the second connector are compatible, each of the first connector and the second connector is a multi-pin connector, the number of the multiple chargers and the number of the multiple rechargeable batteries are each a multiple of four and correspond to each other.
